(19) United States
(12) Patent Application Publication
(10) Pub. No.: US 2002/0136132 A1
(43) Pub. Date: Sep. 26, 2002

(54) Method for controlling balance of photodetector and apparatus thereof

(76) Inventors: Jong-ryull Kim, Gyeonggi-do (KR); Pyong-Yong Seong, Seoul (KR); Hyun-seob Choi, Gyeonggi-do (KR); Young-kug Yoon, Gyeonggi-do (KR); Jong-koog Lee, Seoul (KR)

Correspondence Address: STAAS & HALSEY LLP, 700 11TH STREET, NW, SUITE 500, WASHINGTON, DC, 20001, US

(21) Appl. No.: 10/004,535

(22) Filed: Dec. 6, 2001

(30) Foreign Application Priority Data
Jan. 20, 2001 (KR) 2001-3421

(51) Int. Cl. G11B 7/135

(52) U.S. Cl. 369/53.28; 369/112.1; 369/120

(57) ABSTRACT

A method of controlling a balance of a photodetector capable of increasing light reception efficiency thereof in a compatible optical pickup and an apparatus thereof. The method includes installing first and second light sources in a single module; directing light supplied from the first or second light source and transmitted through a holographic optical element, an optical path changing unit, and an objective lens onto a disk corresponding to each light source, transmitting the light reflected from the disk through the objective lens, and the optical path changing unit to a photodetector, moving the photodetector so that the center of a first one of first and second spots received by the photodetector is concentric with the center of the photodetector; and moving the holographic optical element so that the center of the second received spot from the second light source is concentric with the center of the photodetector. Accordingly, the method allows a photodetector balance to be controlled optimally for first and second light sources in an optical module having the first and second light sources in a single module.

### CROSS-REFERENCE TO RELATED APPLICATIONS

This application claims the benefit of Korean Patent Application No. 2001-3421 filed on Jan. 20, 2001, in the Korean Industrial Property Office, the disclosure of which is incorporated herein by reference.

### BACKGROUND OF THE INVENTION

1. Field of the Invention

The present invention relates to a method of controlling the balance of a photodetector so as to increase the light reception efficiency thereof in a compatible optical pick-up, and an apparatus thereof.

2. Description of the Related Art

In order to achieve compatibility with the compact disc (CD) family of recording media, an optical recording and/or reproducing device for a digital versatile disc (DVD) capable of high density information recording and/or reproducing is required to record and reproduce information on media such as the CD, CD-R (Recordable), CD-RW (Rewritable), CD-I (Interactive), and CD-G (Graphical).

However, while the standardized thickness of the existing CD family recording media is 1.2 mm, the standardized thickness of the DVD is 0.6 mm due to an allowable error of the disk inclination, the numerical aperture (NA) of an objective lens, or the like. Thus, the difference in thickness results in spherical aberrations when an optical pickup for a DVD records and/or reproduces information recorded on a CD. Due to the spherical aberrations, a sufficient light intensity required to record an information signal may not be obtained, or deterioration of a signal may occur during a reproducing operation. Furthermore, light sources used to reproduce DVD- and CD- family media have different wavelengths. For example, the wavelength of the existing reproducing light source for a CD is approximately 780 nm, whereas that for a DVD is approximately 650 nm. Accordingly, a light source used to emit light having different wavelengths and a compatible optical pickup configured to project a light spot onto different positions is required.

Referring to FIG. 1, a conventional compatible optical pickup includes a first light source 10 used to emit light having a wavelength of about 650 nm, and a second light source 20 used to emit light having a wavelength of about 780 nm, these light sources being situated at different positions. The first light source 10 is used with a relatively thin disk 50 such as a DVD, while the second light source 10 is used with a relatively thick disk 52 such as a CD. The light emitted from the first light source 10 is incident on a first beam splitter 15, and the first beam splitter 15 reflects the light toward the disk 50. The light reflected from the relatively thin disk 50 passes through the first beam splitter 15 and is received by a photodetector 60. Here, a reflecting mirror 35 is used to change the path of light emitted from the first and second light sources 10 and 20, a collimating lens 40 is used to create a parallel beam of light, and an objective lens 45 is used to focus incident light on a disk are disposed on a light path between the first beam splitter 15 and the disk 50.

The light emitted from the second source 20 passes through a grating 25 and is reflected by a second beam splitter 30. The light reflected by the second beam splitter 30 reflects off of the reflecting mirror 35, passes through the collimating lens 40 and the objective lens 45, and a light spot is formed on the relatively thick disk 52. The light reflected from the relatively thick disk 52 passes through the objective lens 45 and collimating lens 40, reflects off of the reflecting mirror 35, and passes through the second and first beam splitters 30 and 15, respectively, to be received by the photodetector 60. A converging lens 55 may be disposed between the first beam splitter 15 and the photodetector 60.

As shown in FIG. 2, when the light emitted from the first and second light sources 10 and 20 is received by the photodetector 60, the centers C′ and C″ of the received spots 65a and 65b are required to coincide with the center C of the photodetector 60 in order to increase optical detection efficiency. Focusing the centers C′ and C″ onto the center C of the photodetector 60 is called photodetector balance controlling. Light sources disposed at independent positions as described above makes it easier to control the balance of the photodetector 60 for each light source. That is, the photodetector 60 is moved to control the balance for the first light source 10, and the second light source 20 is moved to control the balance for itself, thereby controlling the photodetector balance easily. This is because the movement of one light source 10(20) does not affect that of the other light source 20(10) since they are disposed at different positions.

On the other hand, if a first light source used with a relatively thin disk and a second light source used with a relatively thick disk are mounted in a module, a conventional balance control method as described above cannot be used since the movement of one light source affects that of the other. Accordingly, it is highly desirable to have a method of controlling the photodetector balance optimally for both light sources in one module.

### SUMMARY OF THE INVENTION

Accordingly, it is an object of the present invention to provide a method of controlling the balance of a photodetector optimally for first and second light sources in one module used to emit light of different wavelengths by rotating or moving a holographic optical element in an optical axis direction.

Additional objects and advantages of the invention will be set forth in part in the description which follows and, in part, will be obvious from the description, or may be learned by practice of the invention.

The foregoing and other objects of the present invention are achieved by providing a method of controlling the balance of a photodetector, the method comprising: installing first and second light sources in a single module; directing light supplied from the first or second light source and transmitted through a holographic optical element, an optical path changing unit, and an objective lens onto a disk corresponding to each light source, transmitting the light reflected from the disk through the objective lens and the optical path changing unit to a photodetector; moving the photodetector so that the center of a first one of first and second spots received by the photodetector is concentric with the center of the photodetector; and moving the holographic optical element so that the center of the second received spot from the second light source is concentric with the center of the photodetector.

In an embodiment of the present invention, moving the holographic optical element is performed by moving the holographic optical element in an optical axis direction to move the center of the second received spot. Alternatively, in an embodiment of the present invention, moving the holographic optical element is performed by rotating the holographic optical element about an optical axis at a predetermined angle to move the center of the second received spot.

### BRIEF DESCRIPTION OF THE DRAWINGS

These and other objects and advantages of the present invention will become apparent and more readily appreciated from the following description of the embodiments, taken in conjunction with the accompany drawings of which:

FIG. 1 illustrates the configuration of a conventional compatible optical pickup;

FIG. 2 schematically illustrates spots received on the photodetector of FIG. 1;

FIG. 3 illustrates the configuration of a compatible optical pickup, to which a photodetector balance controlling method according to the present invention is applied;

FIG. 4 illustrates changes in a photodetector balance with respect to the movement of a holographic optical element about an optical axis according to a photodetector balance controlling method of the present invention; and

FIG. 5 illustrates changes in the position of the second light source with respect to a rotation angle of the holographic optical element according to a photodetector balance controlling method of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures.

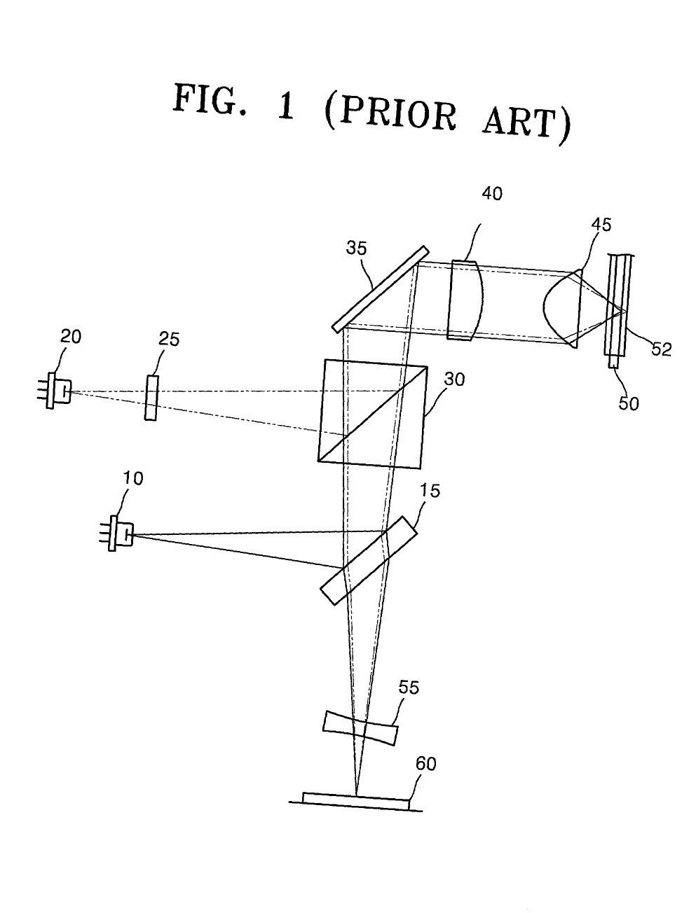

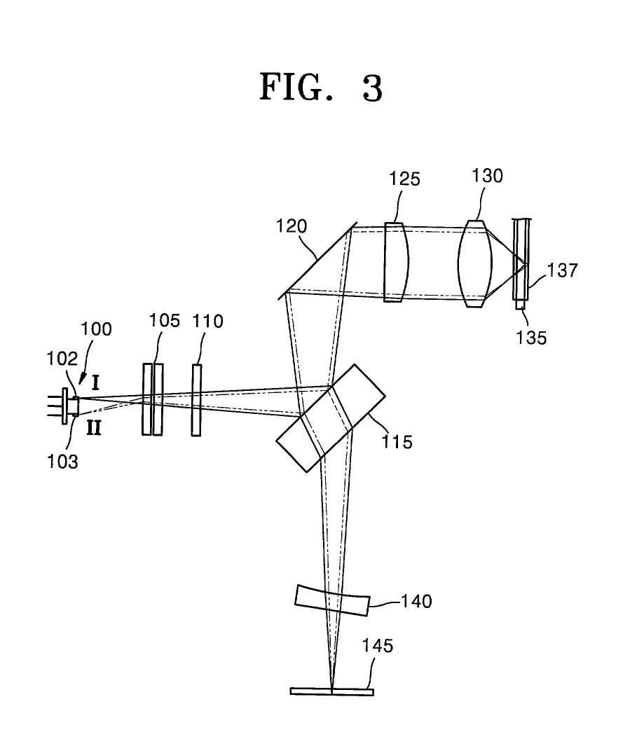

Referring to FIG. 3, a compatible optical pickup having first and second light sources 102 and 103 in a single module includes an optical module 100 constituted by a single unit used to emit first and second light I and II of different wavelengths, a holographic optical element 105 to regulate the first and second light I and II emitted from the optical module 100 to travel along the same optical path, an optical path changing unit 115 to change the path of incident light, an objective lens 130 to focus the incident light on optical recording media 135 and 137, and a photodetector 145 to receive the light reflected from the optical recording media 135 and 137 and passing through the optical path changing unit 115 and the objective lens 130. The reflecting mirror 120, collimating lens 125 and converging lens 140 perform the same functions as those described with reference to FIG. 1.

The optical module 100 is constituted by a single unit including the first and second light sources 102 and 103 of different wavelengths. The optical path changing unit may be a plate beam splitter 115, for example, and a grating 110 may be disposed between the holographic optical element 105 and the plate beam splitter 115. Here, the first and second light sources 102 and 103 are a laser diode, for example, an edge light-emitting diode emitting light on sides, and emits light at different divergence angles. The first light I having a wavelength of about 650 nm emitted from the first light source 102 is suitable to use with the relatively thin optical disk 135, such as a DVD used as an optical recording medium. The second light II having a wavelength of about 780 nm emitted from the second light source 103 is appropriate to use with the relatively thick optical disk 137, such as a CD used as the optical recording medium.

Here, the distance between the first and second light sources 102 and 103 is on the order of 100 μm and the allowable rotation angle relative to each other is in the range of 5-40 degrees. First, the photodetector 145 is moved such that the balance of the photodetector 145 is optimally adjusted for the first light source 102. Then, the balance of the photodetector 145 is adjusted for the second light source 103. To accomplish this, it is not possible for the second light source 103 to be moved to control the balance of the photodetector 145 as in the conventional art, because the balance of the photodetector 145 has already been optimally adjusted for the first light source 102 and the first and second light sources 102 and 103 constitutes a single module.

Thus, the holographic optical element 105 is moved to control the balance of the photodetector 145 for the second light source 103. In this case, the holographic optical element 105 is moved in the optical axis direction or rotated about the optical axis to control the balance of the photodetector 405.

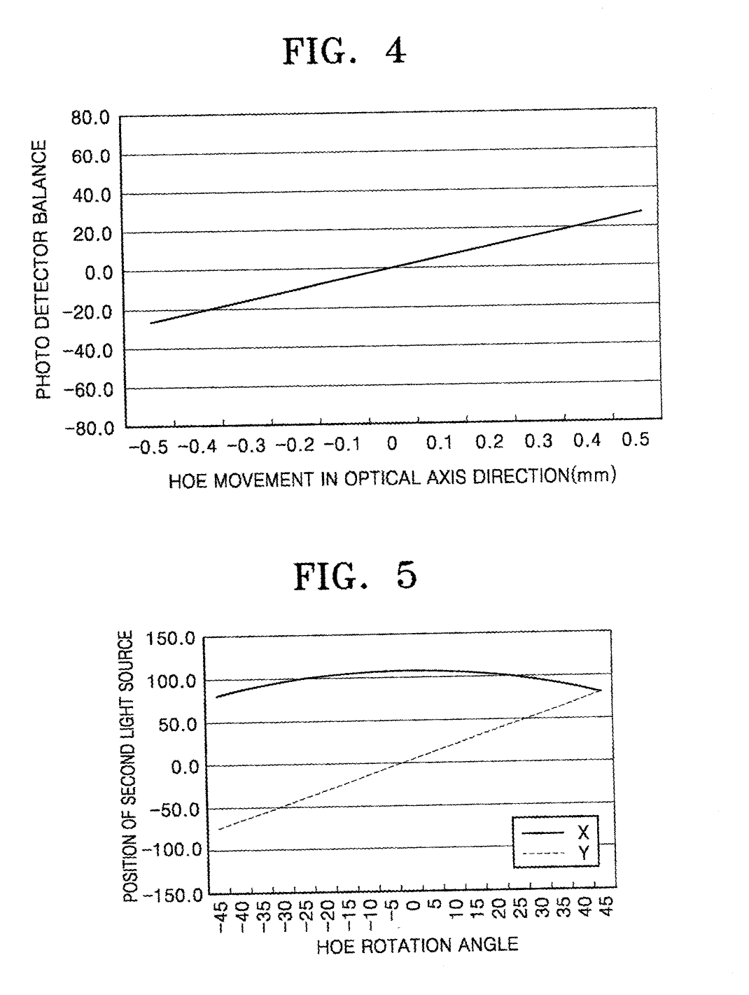

In association therewith, FIG. 4 illustrates the result of measuring changes in the photodetector balance with respect to movement of the holographic optical element 105 in the optical axis direction. As evident from FIG. 4, the balance position of the photodetector 145 is substantially linearly proportional to the movement of the holographic optical element 105 in the optical axis direction. Thus, a linear movement of spots projected onto the photodetector 145 is controlled by the movement of the holographic optical element 105 in the optical axis direction. In this case, since the center of the optical axis of the holographic optical element 105 cannot be changed, the optical path from the first light source 102 is not affected by the movement of the holographic optical element 105 in the optical axis direction. Thus, the photodetector balance of the first light source 102 remains constant when the holographic optical element 105 is moved in the optical axis direction. Table 1 illustrates experimental data of changes in the balance position of the photodetector 145 with respect to the movement of the holographic optical element in the optical axis direction.

TABLE 1

| Movement of holographic element in | |
|---|---|
| optical axis direction | Photodetector balance position |
| −0.4 | −21.6 |
| −0.3 | −16.2 |
| −0.2 | −10.8 |
| −0.1 | −5.48 |
| 0.0 | 0.0 |
| 0.1 | 5.4 |
| 0.2 | 10.8 |
| 0.3 | 16.2 |
| 0.4 | 21.6 |

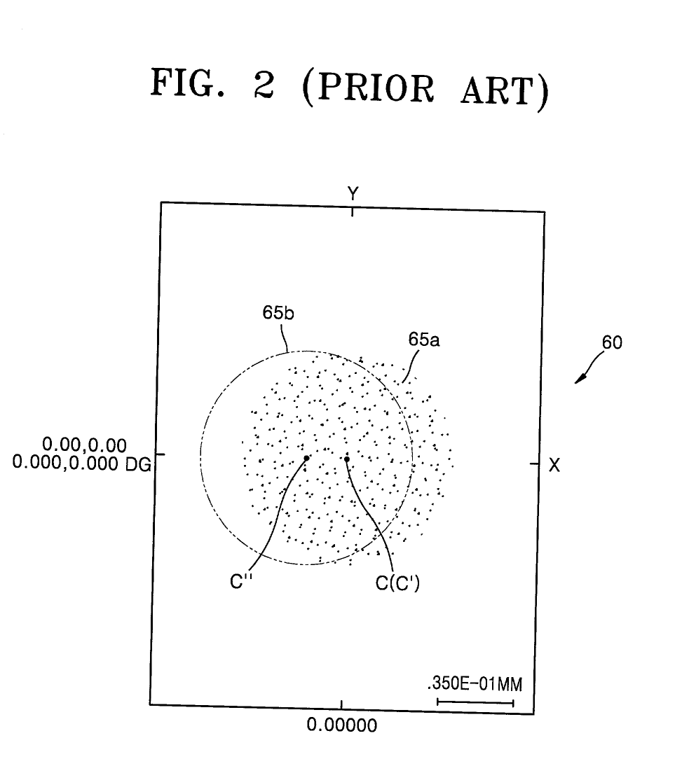

FIG. 5 illustrates changes in relative position of the second light source 103 when the holographic optical element 105 is rotated about the optical axis. Here, X and Y denote movements of position with respect to the X- and Y- axes, respectively, assuming that axis of abscissas and axis of ordinates, which pass through the center C (See FIG. 2) of the photodetector 145, are denoted by X- and Y-axes, respectively. The holographic optical element 105 is rotated in this way to enable the balance of the photodetector 145 to be precisely controlled. In this case, since the center of the holographic optical element 105 is not changed, the photodetector balance optimally adjusted for the first light source 102 is not affected by the rotation of the holographic optical element 105.

That is, when the photodetector 145 is moved to optically adjust the photodetector balance for the first light source 102, it can be considered that the second light source 103 is relatively moved due to the movement of the photodetector 145. Thus, the relative movement of the second light source 103 is compensated for by the movement of the holographic optical element 105 to control the balance of the photodetector 145.

For example, if the relative distance between the first and second light sources 102 and 103 changes in the range of 110 μm±10 μm, the holographic optical element may be moved along the optical axis to control the relative distance therebetween. Alternatively, if the distance between the first and second light sources 102 and 103 is 110 μm and the positioning in the x and y direction (dx and dy) is changed, the difference corresponding to changes in distance dx and dy may be adjusted by rotating the holographic optical element 105. The dx and dy represent infinitesimal changes in distance in the X and Y directions, respectively. Here, the allowable rotating angle of the second light source relative to the first light source 102 is in the range of 5-40 degrees. In this case, the movement of the holographic optical element 105 does not affect defocusing.

As described above, when the first and second light sources 102 and 103 constitute a single optical module according to the present invention, the holographic optical element 105 is appropriately rotated about an optical axis or moved in an optical axis direction to precisely control the balance of the photodetector 145.

This invention makes it possible to precisely control the balance of a photodetector if first and second light sources are constituted by a single module as described above. A holographic optical element is moved in an optical axis direction and rotated along an optical axis, thereby controlling the balance of the photodector in an efficient and precise way and increasing light reception efficiency of a photodetector for each light source. Accordingly, this invention offers the balance of the photodetector to be adjusted optimally for each light source in assembling a compatible optical disk having light sources in a single module.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A method of controlling the balance of a photodetector in an optical recording and/or reproducing apparatus having first and second light sources in a single module, the method comprising:
directing light supplied from the first or second light source and transmitted through a holographic optical element, an optical path changing unit, and an objective lens onto a disk corresponding to each light source, transmitting the light reflected from the corresponding disk through the objective lens, and the optical path changing unit to the photodetector, moving the photodetector so that a center of a first spot received from said first light source by the photodetector is concentric with the center of the photodetector; and
moving the holographic optical element so that a center of a second received spot received from the second light source is concentric with the center of the photodetector.

2. The method of claim 1, wherein the moving of the holographic optical element comprises moving the holographic optical element in an optical axis direction to move the center of the second received spot.

3. The method of claim 2, wherein the moving of the holographic optical element comprises rotating the holographic optical element about an optical axis at a predetermined angle to move the center of the second received spot.

4. The method of claim 1, wherein the moving of the holographic optical element comprises rotating the holographic optical element about an optical axis at a predetermined angle to move the center of the second received spot.

5. A method of controlling the bala nce of a photodetector in an optical recording and/or reproducing device having first and second light sources fixed in position relative to each other, the method comprising:
moving the photodetector so that first light from the first light source and reflected from a corresponding first optical disk is concentric with the photodetector; and
moving a holographic optical element, which does not affect an optical path of the first light, so that second light from the second light source and reflected from a corresponding second optical disk is concentric with the photodetector.

6. The method of claim 5, wherein the moving of the holographic element comprises moving the holographic optical element in an optical axis direction so that the second light is concentric with the photodetector.

7. The method of claim 5, wherein the moving of the holographic element comprises rotating the holographic optical element about an optical axis so that the second light is concentric with the photodetector.

8. The method of claim 5, wherein the moving of the holographic element comprises moving the holographic optical element in an optical axis direction and rotating the holographic element about the optical axis so that the second light is concentric with the photodetector.

9. An apparatus to control the balance of a photodetector to increase the light reception efficiency from an optical recording medium, comprising:
an optical module having a first and a second light source to respectively emit first and second lights of different wavelengths;
a movable holographic optical element to regulate positioning of one of the first and second lights emitted from said optical module;
an optical path changing unit to receive and change the path of incident light received from said movable holographic optical element;
an objective lens to receive incident light received from said optical path changing unit and focus the same on the optical recording medium; and
a photodetector to receive first and second light spots from the light reflected from the optical recording medium and transmitted through said objective lens and said optical path changing unit;
wherein the photodetector is movable to regulate positioning of the other one of said first and second light spots.

10. The apparatus of claim 9, wherein said holographic optical element is movable in an optical axis direction to move the one of said first and second light spots received by said photodetector so that the one light spot is concentric with said photodetector.

11. The apparatus of claim 9, wherein said holographic optical element is rotatable about an optical axis at a predetermined angle to move the one of said first and second light spots received by said photodetector so that the one light spot is concentric with said photodetector.

12. The apparatus of claim 9, further comprising:
a grating positioned between the holographic optical element and the optical path changing unit.

13. An optical recording and/or reproducing apparatus comprising:
first and second light sources fixed in position relative to each other;
a photodetector movable so that first light from the first light source and reflected from a corresponding first optical disk is concentric with the photodetector; and
a holographic optical element, which does not affect an optical path of the first light, movable so that second light from the second light source and reflected from a corresponding second optical disk is concentric with the photodetector; and
an optical path changing unit directing the first and second light from the respective first and second light sources to the corresponding first and second disks, and directing the reflected first and second lights to the photodetector.

14. The optical recording and/or reproducing apparatus of claim 13, wherein the holographic optical element moves in an optical axis direction so that the second light is concentric with the photodetector.

15. The optical recording and/or reproducing apparatus of claim 13, wherein the holographic optical element rotates about an optical axis so that the second light is concentric with the photodetector.

16. The optical recording and/or reproducing apparatus of claim 13, wherein the holographic optical element moves in an optical axis direction and rotates about the optical axis so that the second light is concentric with the photodetector.
